(19) United States
(12) Patent Application Publication
(10) Pub. No.: US 2017/0139702 A1
(43) Pub. Date: May 18, 2017

(54) METHOD OF CLOUD ENGINEERING SERVICES OF INDUSTRIAL PROCESS AUTOMATION SYSTEMS

(71) Applicant: HONGTAO YOU, SUGAR LAND, TX (US)

(72) Inventor: HONGTAO YOU, SUGAR LAND, TX (US)

(73) Assignee: YOUWARE COMPANY, SUGAR LAND, TX (US)

(21) Appl. No.: 14/941,624

(22) Filed: Nov. 15, 2015

(51) Int. Cl. G06F 9/44; G06Q 50/04; G06Q 10/10

(52) U.S. Cl. CPC G06F 8/70; G06Q 10/103; G06Q 50/04

(57) ABSTRACT

This invention provides a method of cloud engineering services of industrial process automation systems. It can be used by users of both developers and customers. Implemented by cloud based hardware/software, in minimum, it comprises four types of blocks—the User Interface block, the Users block, at least one Virtual System block, and at least one Engineering Process block, wherein the User Interface block is a website application and/or a mobile device application; the Users block keeps users' profile, users' data including documents and binary files, and users' reviews; a Virtual System block is a cloud based virtual industrial process automation system simulating instrumentation data, functionalities of process controllers, and computer servers/workstations; and an Engineering Process block is a cloud based engineering service project, initiated by a project owner user, providing Virtual Systems and other cloud based resources, providing virtual desktop computers and/or server sessions for invited developer users, keeping project data including documentation and binary data, and managing project reviews. It can further comprise the Objects block, allowing owners/developers to upload saleable objects, keeping object binary data and object specification, and managing object reviews. It can further comprise the Market Place block, managing sale items, open order services, and closed order archive. The saleable items include saleable objects, engineering services, and rentals of Virtual Systems and other cloud based resources. The advantage of this invention is that all saleable items and/or user/object/project reviews are able to get validation via a Virtual System and/or project archives.

### TECHNICAL FIELD

The invention is relates to industrial process automation systems.

### BACKGROUND OF THE INVENTION

An industrial process automation system, called Automation System hereinafter, is used to monitor and control industrial manufacturing and/or material transportation processes, such as a production line, a chemical plant production unit, or a pipeline. All Automation Systems are proprietarily developed by manufacturers. Most Automation Systems, if not all, consist of all or portions of traditional and/or smart instrumentation, programmable logic controllers and/or process controllers, server computers and/or computer workstations, and networking infrastructure for different network layers such as instrumentation networks, process control networks, and computer networks.

An industrial manufacturing and/or material transportation process is monitored and controlled by a number of points that have analog or discrete values. These points are measured by instruments, and their values represent the status of the process. These points can be inputs (for monitoring) and/or outputs (for control). The process controller of an Automation System may have algorithms that take inputs of the process plus certain parameters of control settings, and calculate the outputs to monitor and/or control the process.

An Automation System always has a configuration database, which contains the definitions of all process points to be monitored and/or controlled, and control algorithms. The configuration database also contains all parameters that will determine the Automation System behaviors.

Process points can be managed into so-called tags and/or objects. Each tag represents a process point, while an object may represent a group of related process points such as all related points of a valve. A tag can also be referred to as a special format of an object. Operators use the custom developed human machine interface, called HMI hereafter, to view the data values of objects, respond the alarms/events occurred in objects, and make changes to objects in order to control the processes. A historian in an Automation System is used to store the historical data of the runtime objects and/or transitional data records such as alarms/events.

Vendors provide engineering services to design and develop custom built Automation Systems for customers. Examples of engineering services include but not limit to project management, front-end-engineering-design, project design specification, hardware/software procurement, system assembly and staging, system configuration, system testing, factory acceptance test, on-site commissioning and start-up, and site acceptance test. Other examples of engineering services include maintenance services of an Automation System in production, system configuration changes during production, and system upgrade.

There is a specific style of Automation System, in which system there is no physical instrumentation input/output component. Furthermore, the programmable logic controller and/or process controller can be simulated by computer software, called Virtual Process Controller hereinafter. Computers including servers and/or workstations can be virtualized to, meaning at least one computer with operating system run on a shared computer hardware platform. This style of Automation System is used as a development version of Automation System for development of configuration database with control logics, and/or an operator training system.

Today, there is web based file sharing and meeting conference to bring customer and vendor together. But each Automation System is still staged and/or developed in either vendor's facility or customer's facility, while the majority of the engineering services are performed at the site of the system. By this nature of the engineering services, an Automation System is most likely developed by a single vendor. Customer normally has much less influence on selecting specific engineers and/or specialists who actually perform the engineering services.

### SUMMARY OF THE INVENTION

This invention provides a method of cloud engineering services of Automation Systems, called Cloud Engineering Services hereinafter. It provides an environment of Automation System engineering services for users of both customers and developers. A user can setup a group activity by inviting other users. A group activity can be considered as an engineering service project. In one case, a developer can demonstrate the products and services for invited customers. In another case, a customer can invite a number of developers to bid on a design and/or engineering services. Cloud Engineering Services provides engineering service project archive and object library, so that the reusable objects and project practices can be saleable among users. Cloud Engineering Services provides virtual Automation System so that the developed component can be demonstrated and/or tested. It brings customer and developer completely together in a running environment. During an engineering service project, customer can monitor the actual development progress instead of being limited to the traditional project paperwork. Cloud Engineering Services allows users to enter performance review for users and/or projects. Any disagreement can be judged by demonstration of archived component in virtual Automation System.

Today, many reusable engineering components are managed by each vendor, even by individual developers in their personal archives. Cloud Engineering Services provides the space for all developers to share their reusable components. Traditionally, users published white papers to introduce their recommended practices, or vendors brought laptops to show demos to customers in visits, or vendors organized web conferences to show demos to customers. Cloud Engineering Services provides an environment for users to demonstrate an Automation System and/or any of engineering components at customer's convenience.

### BRIEF DESCRIPTION OF THE DRAWINGS

The invention may best be understood by reference to the following description taken in conjunction with the accompanying drawings in which:

FIG. 1 is a perspective basic diagram of cloud components that accomplish the invented method of cloud engineering services of industrial process automation systems, comprising the User Interface block, the Users block, at least one Virtual System block, and at least one Engineering Process block.

FIG. 2 is a perspective diagram of cloud components that accomplish the invented method of cloud engineering services of industrial process automation systems, comprising all blocks in FIG. 1, and further the Objects block.

FIG. 3 is a perspective diagram of cloud components that accomplish the invented method of cloud engineering services of industrial process automation systems, comprising all blocks in FIG. 2, and further the Market Place block.

### DETAILED DESCRIPTION OF THE INVENTION

Today, an Automation System is most likely proprietarily built by a vendor. The vendor will normally provide a limited warrantee and annual maintenance support. Based on this business model, a customer keeps very minimum technical specialists, and highly depends on the vendor. It forms a small and closed society. The Automation System will run until becoming obsolete, and most likely evolve at a pace behind the dynamics of business and technology.

This invention provides a method of a generic Cloud Engineering Services for users of both customers and developers. It forms a broader technical society of technologies and development resources related to Automation Systems. It is not an online forum and/or information sharing, which has no means of online verification of any solution and/or recommendation. It has a running cloud based Automation System development environment to allow a group of users to work on any ideas online.

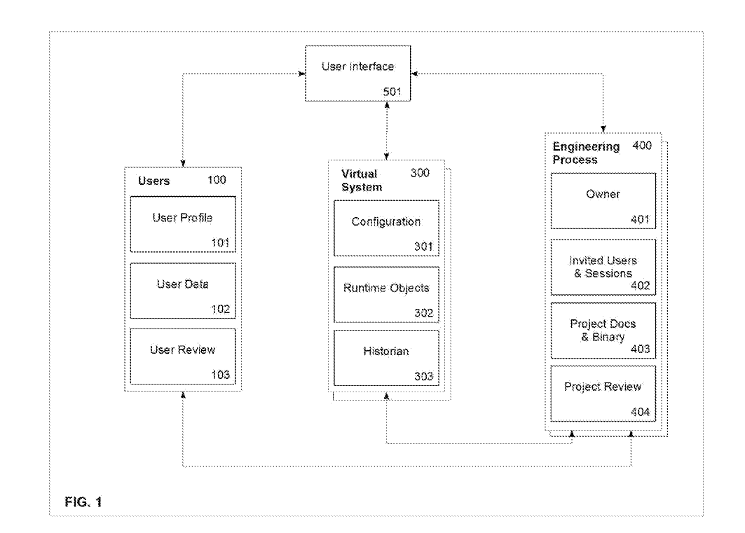

In FIG. 1, Block 100 is the block diagram of a typical Users block. Users block is implemented by cloud based computer hardware/software.

Block 101 is the User Profile module. It keeps user information for both customers and developers. A user can be a customer in one project of an engineering process, and be a developer in another project of an engineering process.

Block 102 is the User Data repository. User data can be any documentation or binary files of any engineering development.

Block 103 is the User Review repository. It keeps the trails of review cases. A review may have attachment of binary data of the engineering service, or the reference, that may be able to get verification in Virtual System—Block 300.

In FIG. 1, Block 300 is the block diagram of a typical Virtual System. Each of Block 300 will simulate one instance of Automation Systems. Multiple instances of Virtual Systems can be the same type of Automation Systems, or can be different types of Automation Systems. A Virtual System is implemented by cloud based computer hardware/software. It does not have physically identifiable instrumentation, process controllers, and computer servers/workstations like an actual Automation System. Instead, a Virtual System simulates instrumentation data, the functionalities of process controllers, and computer servers/workstations of Automation Systems. Different from an Automation System utilizing virtualization technology in which the actual hardware of virtualized Automation System is still physically identifiable from user's point of view, the cloud based Virtual System implemented in this invention has cloud hardware not physically identifiable from user's point of view. In another word, a user physically owns an Automation System that utilizes virtualization technology; while a user normally does not physically own the cloud based Virtual System, and only uses the functional services of the Virtual System, unless the user owns the whole cloud.

A user can request a whole Virtual System for any particular purpose. For example, a developer can request a whole Virtual System to demonstrate a special system to other users. For another example, a customer can request a whole Virtual System, and invite a group of developers to build a specific Automation System. In these cases, the engineering services for a whole Virtual System are performed.

A user can request to use a Virtual System shared with other users. The user can upload/modify its own objects, run/test the objects. In this case, the engineering services for objects are performed, but not for a whole Virtual System.

Block 301 is the Configuration repository of a Virtual System—Block 300. It can have the configuration of an actual corresponding Automation System that the Virtual System simulates. It can also have the configuration that contains the process points for multiple users and different purposes, which means that multiple users are sharing the same Virtual System. Block 301 has the development tools to develop and manage the configuration.

Block 302 is the module containing the Runtime Objects. Corresponding to Block 301, Block 302 can simulate the runtime process points of Automation Systems. These simulated process points can be points of a simulated Automation System, in which case the whole Virtual System—Block 300 is normally requested by a user. These points can be from multiple users for different purposes, in which case the Virtual System—Block 300 is shared by multiple users.

Block 303 is the historian of the Virtual System—Block 300. It has history configuration derived from Configuration—Block 301. It keeps the historical data of Runtime Objects—Block 302, and transitional records such as alarm/event records occurred in Block 302.

In FIG. 1, Block 400 is a typical block diagram of an Engineering Process that can be considered as an engineering service project. Multiple blocks of Block 400 represent multiple simultaneous Engineering Processes.

An Engineering Process always has an owner. In another word, a user who initiated an Engineering Process will become the owner of the initiated Engineering Process. The owner can request the use of Virtual Systems, and perform any engineering development by itself. The owner can also invite other users, in order to demonstrate a solution to other users, or to ask other users for engineering services.

Block 401 is the Owner module, which contains all information of the Engineering Process initiated by the owner, such as the description of the engineering process or scope of work, request of usage of Virtual Systems. It also contains the management of this engineering process, such as storage space, other cloud resources like a virtual desktop computer or a server session, invitation of other users, and security setting for different user's access.

Block 402 is the module of Invited Users & Sessions. It can provide the data access to the invited users, such as the owner's objects and/or the owner's whole Virtual System. It can also include the work spaces for the invited users, such as cloud based virtual desktop computers and/or server sessions.

Block 403 is the module of Project Docs & Binary. This is the storage space used to archive the data of the Engineering Process. After the completion of the Engineering Process, the owner can return the requested Virtual System and other cloud based resources, but the owner may want to keep the project archive for future reference and/or demonstration. Owner decides the data access from other users.

Block 404 is the module of Project Review. This is normally the public information, such as a white paper of the project, reviews by the owner and/or other users involved in the project. Since a Virtual System can be used to validate any review, a review without validation can be easily discounted by other users.

In FIG. 1, Block 501 is the user interface for users to utilize this invented cloud based engineering services of Automation System. It can be a web site application, and/or a mobile device application.

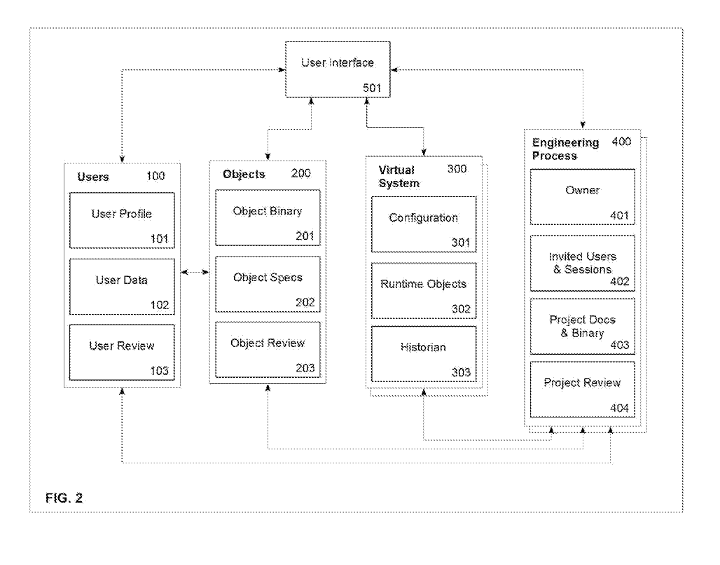

FIG. 2 includes all blocks in FIG. 1, and further comprises the Block 200, which is an object library.

Users of both developers and owners can publish the developed objects into this object library—Block 200. With the availability of Virtual System, the developed objects can be easily validated. Other users can request owners and/or developers to demonstrate the interested objects.

Block 201 is the object binary repository. It contains the object executable files and/or installation files that users uploaded. The object binary files are only accessible by the developers and/or owners, and future buyers. But certain file information may be published to other users, such as file names, sizes, versions, and dates.

Block 202 is the module of object specifications that the developers and/or owners published.

Block 203 is the module of object reviews. This is the public information, such as a white paper of the objects, reviews by the users for object assessment. Since a Virtual System can be used to validate any review, a review without validation can be easily discounted by other users.

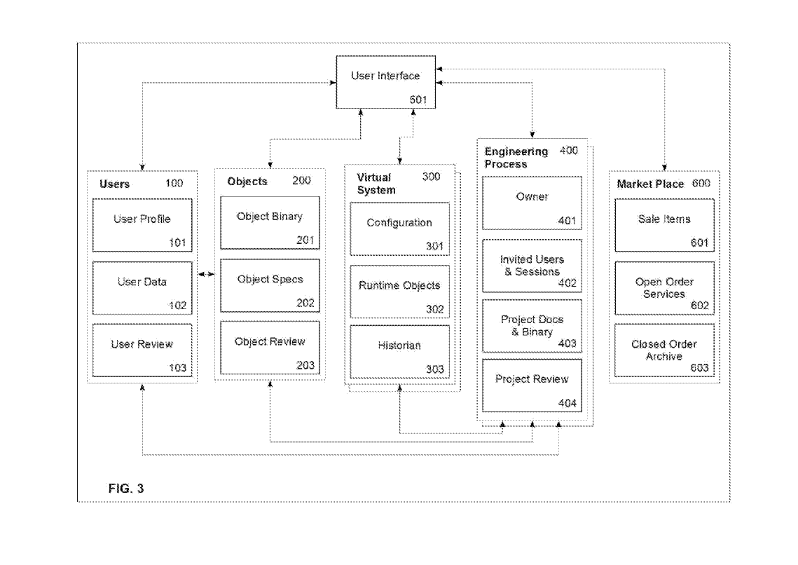

FIG. 3 includes all modules in FIG. 2, further comprises a Block 600. Block 600 is the Market Place where sales are managed.

Block 601 is the module of sale items. The sale items include cloud based Virtual System rental, cloud based resource rental such as virtual desktop computers and/or server sessions, cloud based storage spaces, published objects for sale, and engineering services.

Block 602 is the module of open order services, such as order information, payment, delivery, return or replacement, refund, etc.

Block 603 is the archive of history orders.

What is claimed is:

1. A cloud computing hardware/software implemented method of cloud engineering services of industrial process automation systems, comprising:
one Users block that manages all users; at least one Virtual System, each Virtual System providing a virtual industrial process automation system as a virtual development or demonstration environment; at least one Engineering Process block, each Engineering Process, initiated by an owner user, managing an engineering process project, and archiving project documentation and engineering binary data; and one User Interface, being a web site application and/or a mobile device application.

2. The method of claim 1 wherein Users block comprises a module of user profile, providing all user information; a module of User Data repository, providing a storage space for user to keep documentation and/or binary data of any engineering development; and a module of User Review repository, where any user review can get validation from a Virtual System and/or records in Engineering Processes of claim 1, so that the dishonored review can be prevented.

3. The method of claim 1 wherein a Virtual System block comprises a module of Configuration, containing system configuration and/or process points' configuration of an industrial process automation system, and having the development tools to manage the configuration; a module of Runtime Objects, where all or a portion of configured objects in Configuration module run in the runtime environment, to simulate instrumentation data, the functionalities of process controllers, and computer servers/workstations; and a module of Historian, keeping the historical data of runtime process points and transitional records such as alarm/event records occurred in runtime objects.

4. The method of claim 1 wherein an Engineering Process block comprises a module of Owner, providing the information of the owner user who initiated the engineering process project, the scope of work of the project, the request of usage of Virtual Systems, the request of other cloud resources such as virtual desktop computers and/or server sessions, the request of project storage space, etc.; a module of Invited Users & Sessions, providing the information of invited users who will join the project, and the allocated cloud resources for users such as the virtual desktop computers and/or server sessions; a module of Project Docs & Binary, being a project storage space to keep project documentation and development binary data; and a module of Project Review, where any review of the project can get validation from a Virtual System and/or records in the module of Project Docs & Binary, so that the dishonored review can be prevented.

5. The method of claim 1 further comprises the Objects block, keeping user published objects with executable binary and specification, and having object reviews that can be validated through a Virtual System.

6. The method of claim 5 wherein the Objects block comprises a module of Object Binary, keeping object executable files and/or installation files; a module of Object Specs, keeping published object specification documents; and a module of Object Review, keeping user published white papers and/or reviews.

7. The method of claim 1 or 5 further comprises the Market Place block, listing saleable items, managing open orders, and archiving closed orders.

8. The method of claim 7 wherein the Market Place block comprises a module of Sale Items, listing all saleable items such as objects uploaded by developers and/or owners, projects of engineering process, Virtual System rentals, and rentals of other cloud based resources like virtual desktop computers and/or server sessions; a module of Open Order Services, tracking open order information, managing payment, handling return/replacement/refund, etc.; and a module of Closed Order Archive, keeping records of closed orders.
